(19) United States
(12) Patent Application Publication
(10) Pub. No.: US 2021/0298370 A1
(43) Pub. Date: Sep. 30, 2021

(54) Upper Body Positive Pressure Protection Suit

(71) Applicant: AeroMed Leasing, LLC, Indianapolis, IN (US)

(72) Inventor: Jason C. Watters, Indianapolis, IN (US)

(21) Appl. No.: 17/218,073

(22) Filed: Mar. 30, 2021

Related U.S. Application Data
(60) Provisional application No. 63/012,322, filed on Apr. 20, 2020.
(60) Provisional application No. 63/005,475, filed on Apr. 6, 2020.
(60) Provisional application No. 63/101,235, filed on Mar. 30, 2020.

(51) Int. Cl. A41D 13/002; A62B 17/00; A62B 23/00

(52) U.S. Cl. CPC A41D 13/0025; A62B 23/00; A62B 17/006

(57) ABSTRACT

An upper body positive pressure protection system protects the user from aerosolized contaminants and isolates a user's entire upper body from a contaminated environment. Filtered air is supplied to the suit by a reusable, rechargeable blower unit to ensure a non-contaminated and portable air supply for continuous positive pressure to the upper body suit. The blower unit is portable with the user and can be supported by a shoulder and waist belt harness. The reusable or disposable upper body suit can be constructed from a lightweight, splash/fluid resistant material that incorporates a clear face shield to allow appropriate visibility to the user. A reusable, adjustable head harness worn within a hood of the suit provides fixed positioning of the face shield relative to the user's face. Suit air exit vents may optionally include filters for capturing any biological contaminants the user may be expelling.

### CROSS-REFERENCE TO RELATED APPLICATION

This is a nonprovisional patent application of: U.S. Provisional Patent Application No. 63/101,235, filed Mar. 30, 2020, and titled Anti-viral/Anti-microbial/Industrial Positive Pressure Partial Suit; U.S. Provisional Patent Application No. 63/005,475, filed Apr. 6, 2020, and titled Anti-viral/Anti-microbial/Industrial Portable Partial Positive Pressure Suit; and U.S. Provisional Patent Application No. 63/012,322, filed Apr. 20, 2020, and titled Novel Portable Partial Positive Pressure Suit, all of which are incorporated herein by reference.

### TECHNICAL FIELD

Embodiments of this disclosure relate generally to personal protection equipment and more particularly to positive pressure protection garments and respirators.

### BACKGROUND

Personal protection equipment (PPE) provides the wearer a low-level of barrier protection from contaminants that are sprayed, aerosolized, covering surfaces, or otherwise present and likely to be contacted in a work or other environment. Traditional basic barrier PPE include face masks, gowns, and eyewear to protect from contaminants, but are not sufficient for protection for all environments and for all forms of contaminants. Another shortfall with basic PPE masks, including N95 masks and the like, is they can be very uncomfortable with extended wear and are known to sometimes cause skin breakdown and extensive bruising.

Systems providing positive pressure for the encapsulating garments provide additional protection over basic PPE to prevent contaminants from entering the suit and exposing the user, including biological contaminants, as well as chemical contaminants in the form of gases, vapors, and/or particles, depending on the air supply and/or filtering provided.

Prior positive pressure suits encapsulate the user's entire body, which makes donning and doffing difficult, wear and activity cumbersome, prolonged wear uncomfortable, and the significantly higher amounts of garment material and seams increase the likelihood of damage and a resulting point of failure. These challenges are particularly magnified with the billowing that occurs with whole-body positive pressure suits. Additionally, such whole-body systems are expensive and often require a tethered air supply, reducing portability. Despite these drawbacks, such systems are one of the very few choices for use in healthcare and in industrial applications when basic PPE is not sufficient.

Another type of known personal protection system is a powered air-purifying respirator (PAPR), which can provide related protective benefits as discussed above; however, the encapsulated portion of the body is generally limited to only the user's face and/or head and such systems generally lack a sufficient level of positive pressure and fully enclosed environment, thus increasing the risk of exposing the wearer to aerosolized contaminants. Although a common route of infection by biological and aerosolized contaminants is through the mucosal membranes of the eyes, nose, and mouth, activity of some users involves the exposure and/or use of the upper body in ways warranting protection of more than just the face and/or head. The volume rate of airflow provided to a user of a PAPR device is typically 4-5 CFM, which may be insufficient flow and also may provide insufficient static pressure capacity for positive pressure protection, particularly of more than just the user's face. Additionally, the expense of typically available PAPR systems can also make wide-spread use cost prohibitive.

Therefore, there is currently a void between the level of protection and expense associated with a full-body positive pressure suit and the level of protection that basic masks, eyewear, gowns, and PAPR systems provide a user. A need thus exists for a system that is portable, includes a respirator system that does not require a tethered air supply, is relatively inexpensive, and provides at least full upper body protection to users.

As such, it was realized by the inventor of the current disclosure that improvements are needed in current systems that provide protection from aerosolized contaminants.

### SUMMARY

Embodiments of the present disclosure provide a system that protects a user from aerosolized contaminants and isolates the user's upper body from a contaminated environment, including the head, neck, arms, and trunk, with a positive pressure upper body suit and provides features that advantageously overcome the difficulties discussed in the Background above. Filtered air is supplied to the suit by a reusable, rechargeable blower unit to ensure a non-contaminated and portable air supply is available to provide continuous positive pressure to the upper body suit. The blower unit is portable and wearable by the user, for example, supported by a shoulder and waist belt harness. Reusable and disposable variants of the upper body suits can be constructed from lightweight, splash/fluid resistant materials that incorporate a clear face shield to allow appropriate visibility to the user. A reusable, adjustable head harness worn within a hood of the suit provides fixed positioning of the face shield relative to the user's face.

The disclosed system can be used in multiple work and other hazardous environments appropriate to the capabilities of the system, including for many healthcare and industrial applications. The disclosed system has increased ease of donning and doffing, wearability, and comfort for prolonged wear over prior art whole-body systems. Limiting the suit to only upper body coverage provides the advantage of less weight, enhanced mobility, lower cost, and a lower likelihood of a tear resulting in loss of positive pressure. While adaptable to other environments, the disclosed system is particularly useful in environments having aerosolized contaminants, including viruses and other microbes.

In accordance with one embodiment of the present disclosure, a positive pressure protection system for a user, comprises an upper body suit having a jacket, sleeves, and hood portions providing a fluid resistant barrier for the user, the jacket including a waist closure, and the hood portion including a transparent face shield; a carrying harness adapted for wear by the user overtop of the upper body suit; and a blower unit supported by the carrying harness, the blower unit including: a housing; an intake air filter coupled to the housing; a blower fan supported by the housing and having an inlet coupled with the intake air filter and having an outlet; a conduit coupling the blower fan outlet to an interior of the upper body suit; and a power supply supported by the housing and providing electrical power to the blower fan.

The positive pressure protection system can include a face shield support member having a releasable coupling for securing and positioning the face shield relative to the user's face and head; and a head harness for wear on the head of the user, the shield support member supported by the head harness.

The releasable coupling can include a magnetic fastener defined by at least a portion of the shield support member and a portion of the face shield. The intake air filter can include biological reduction grade filter media. The intake air filter can include chemical filter media.

The upper body suit can defines at least one flap covered vent defined therethrough to allow release of exhaled carbon dioxide from the user and sized to maintain positive pressure within the suit. The at least one flap covered vent can be covered with a biological reduction grade filter media, the media providing a barrier to the escape of biological contaminants exhaled or otherwise shed by the user.

The sleeves can include wrist closures. The front of the jacket can include a fluid sealing zipper to aid the user in donning and doffing the upper body suit.

In at least one embodiment of the system, the user can select from an upper body suit constructed of materials suitable for one-time disposable use, and an upper body suit constructed of materials that can be washed or otherwise decontaminated and reused.

The blower fan can be a centrifugal fan. The centrifugal fan can have a combined flow rate capacity and static pressure capacity to deliver at least about 16 cubic feet per minute of filtered air flow to the upper body suit.

The power supply can include rechargeable batteries. The power supply can include a power input connector for recharging the rechargeable batteries onboard and enabling continuous time unbounded operation of the blower unit.

The blower unit can include a receptacle for releasably receiving at least a portion of the power supply within the blower unit. The receptacle can include an opening defined by the blower unit housing and a blower power connector for receiving power from the power supply.

The receptacle can include guides for slidingly receiving at least a portion of the power supply into the blower unit housing; and the receptacle and the power supply can include a releasable retaining device for releasably securing the power supply in the blower unit housing.

The hood can include a hose connector; and the conduit can include a hose releasably connectable to the hose connector for supplying filtered air to the interior of the upper body suit.

In another embodiment, a positive pressure protection system for a user, comprises: an upper body suit providing a fluid resistant barrier for the user, the upper body suit can include a waist closure, wrist closures, and a hood portion including a transparent face shield; a face shield support member having a releasable coupling for securing and positioning the face shield relative to the user's face and head; a head harness for wear on the head of the user, the shield support member supported by the head harness; and a blower unit including: a housing; an ambient air intake filter coupled to the housing; a blower fan located within the housing and having an inlet coupled with the intake filter and having an outlet; a sealed conduit coupling the blower fan outlet to an interior of the upper body suit; and a power supply supported within the housing and providing electrical power to the blower fan. The system can further comprise a carrying harness adapted for wear by the user overtop of the upper body suit, the carrying harness supporting the blower unit and including shoulder straps and a waist belt.

In yet another embodiment, a positive pressure protection system for a user, comprises: a protection suit providing a fluid resistant barrier for the user, the protection suit including at least an upper body portion and further including a hood portion having a transparent face shield; and a blower unit including: a housing; an ambient air intake filter coupled to the housing; a blower fan positioned within the housing and having an inlet coupled with the intake filter and having an outlet; a sealed conduit coupling the blower fan outlet to an interior of the suit; a rechargeable power supply; and a receptacle for releasably receiving at least a portion of the power supply within the blower unit housing; and wherein: the receptacle includes an opening defined by the blower unit housing and a blower power connector for receiving power from the power supply; the receptacle includes guides for slidingly receiving at least a portion of the power supply into the blower unit housing; and the receptacle and the power supply include a releasable retaining device for releasably securing the power supply in the blower unit housing.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as many different combinations and sub-combinations thereof. All such useful, novel, and inventive combinations and sub-combinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 illustrates a front perspective view of a user donning an exemplary embodiment of an upper body positive pressure protection system according to the present disclosure;

FIG. 2 illustrates a rear perspective view of the system of FIG. 1;

FIG. 3A illustrates a partial cutaway rear perspective view of hood, head harness, and blower unit portions of the system of FIG. 1;

FIG. 3B illustrates a partially exploded view of hood, blower unit, and battery cradle portions of the system of FIG. 1;

FIG. 4 illustrates a top cross-sectional view of a hood, face shield, and head harness portion of the system of FIG. 1, taken along cutting plane 4-4 shown in FIG. 3B;

FIG. 5 illustrates a schematic block diagram of the power supply portion of the blower unit of the system of FIG. 1;

FIG. 6 illustrates a side view of a battery cradle of the power supply, with housing cover removed portion, of the power supply of FIG. 5;

FIG. 7 illustrates a front view of the blower unit of the system of FIG. 1, with a cover portion removed;

FIG. 8 illustrates a front view of the blower unit of FIG. 7 with the blower fan and hose removed;

FIG. 9 illustrates a side cross-sectional of the blower unit portion of the system of FIG. 1, taken along cutting plane 9-9 shown in FIG. 3A; and

FIG. 10 illustrates a close-up view of a vented portion of the upper body suit of the system of FIG. 1, the close-up portion as indicated in FIG. 2.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

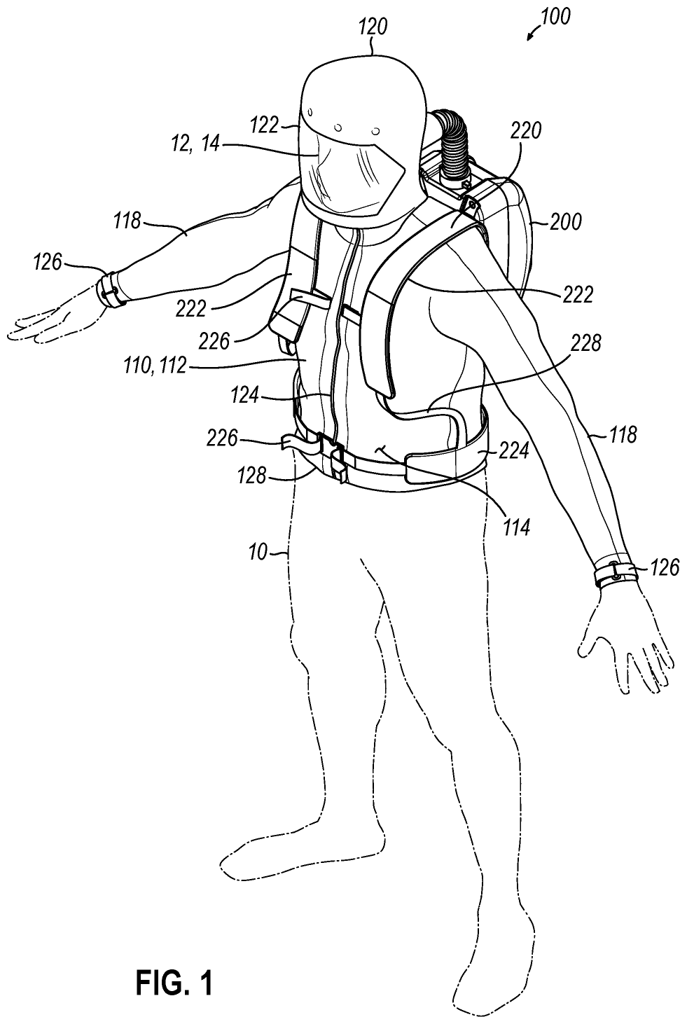

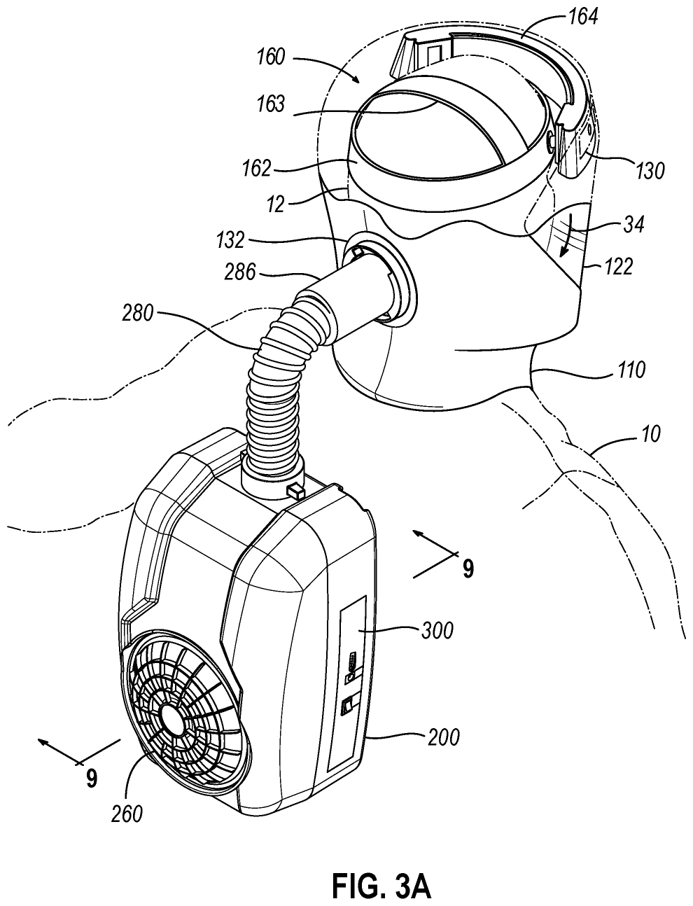

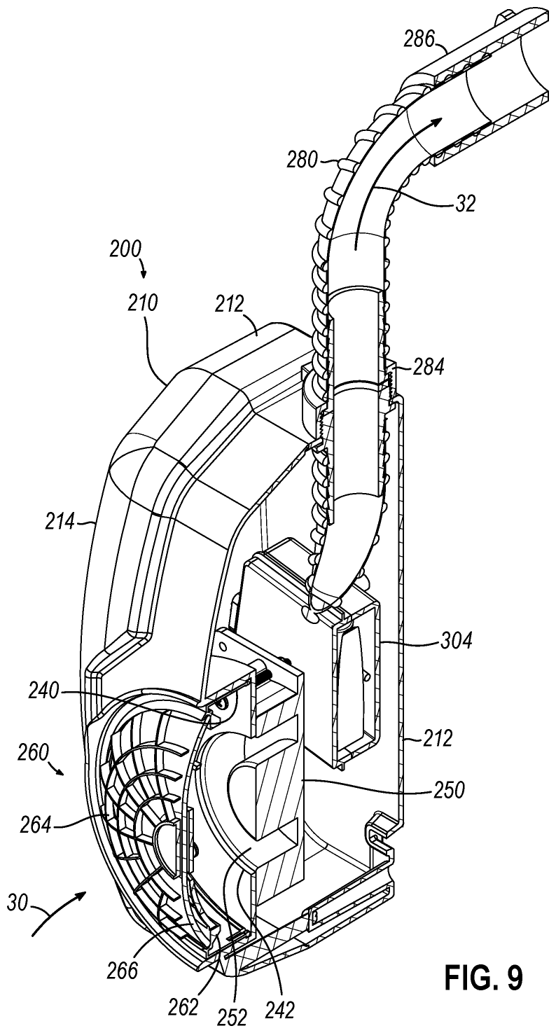

Referring to FIG. 1, a front perspective view of a user 10 donning an illustrative embodiment of an upper body positive pressure protection system 100 according to the present disclosure is shown. The illustrative embodiment of the protective system 100 includes an upper body suit 110, head harness 160 (FIG. 3A), blower unit 200, and carrying harness 220. The blower unit 200 can be supported on the user 10 external of the upper body suit 110, for example, attached to a carrying harness 220 worn by the user over top of the upper body suit. The blower unit 200 can draw in and filter ambient air 30 (FIG. 9), delivering it to an interior of upper body suit 110, thereby providing continuous positive pressure to the upper body suit, thus increasing the level of protection provided beyond that provided by an unaided barrier effect of the upper body suit, and providing a continuous source of filtered air 32 (FIG. 9) to the user for breathing.

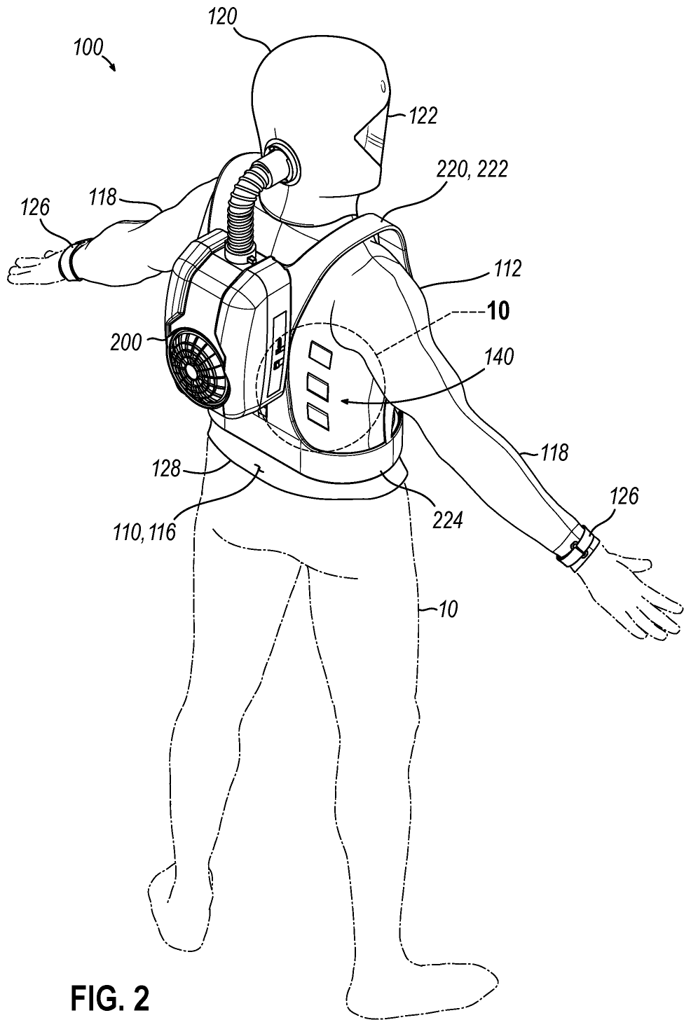

The upper body suit 110 can encompass and enclose the entire upper body of user 10 from the waist up, though the user's hands may be optionally excluded from coverage to allow other protection, for example surgical gloves, to be selected based on the dexterity and level of barrier protection required for a particular task. The upper body suit 110 includes, for example, an enclosure garment type structure having a jacket 112 having a front 114, back 116 (FIG. 2), sleeves 118, hood 120, and transparent face shield 122. The front 114 can include a zipper 124 to provide greater ease in donning and doffing the upper body suit, generally eliminating the need for assistance in doing so.

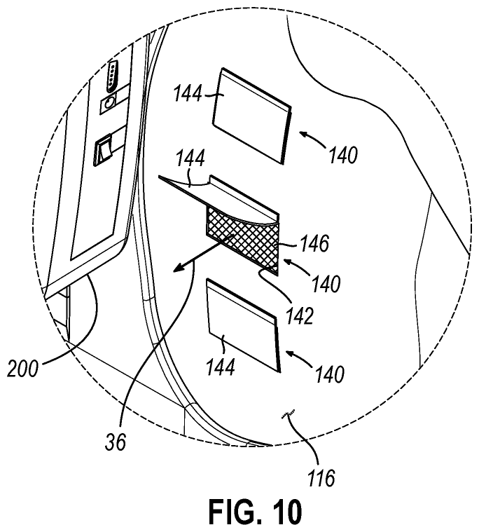

To eliminate or limit leakage of filtered air 32 from openings of the suit 110, wrist closures 126 and a waist closure 128 can be provided, and the zipper 124 can be a fluid resistant or fluid sealing type zipper. For example, the closures 126 can be an elastic band or an adjustable strap to provide an airtight seal at the associated openings, if desired, for example, using a hook and loop type fastener (not shown). The closures 126 and 128 may also have associated rubberized or knitted compression material to aid sealing. In principal, if exhaust air 36 (FIG. 10) is constantly escaping from one or more restricted openings defined by the suit 110 by means of positive pressure, aerosolized contaminants are unable to enter the suit and expose the user 10.

The positive air pressure differential is such that an air pressure gradient is always maintained to facilitate a constant outflow of air and carbon dioxide. The positive pressure also facilitates increased protection from contaminants for suits 110 formed from material that may technically not provide a fluid tight barrier to fluid penetration. For example, the positive pressure escaping outwardly through a weave or other porous feature of material having resistance to fluid penetration prevents contaminants from flowing inwardly through the porous feature of the material, thus preventing contamination of user 10 in environments that involve minimal or otherwise limited fluid spray or immersion risk.

In some embodiments optional vents 140 (FIGS. 2 and 10) guide a desired airflow within and escape location from the suit 110 for the outward flow of exhaust air 36, for example, a combination of exhaled air 34 expelled by the user mixed with filtered air 32 providing sustained positive suit pressure, thus warranting other openings be airtight to prevent excess leakage. For example, vents 140 can each have openings 142 through the material wall of the jacket 112, for example, at opposite sides of back 116. The openings 142 can be sized and numbered to allow a desired limited volume rate of exhaust air 36 to escape, thereby maintaining positive pressure within the suit 110.

The vents 140 may also include protective flaps 144, which the exhaust air 36 force open as needed, and may include optional filters 146, for example providing a HEPA grade or other desired level of filtration, for example, that may be included to protect others in the environment from any biological contaminants that the user 10 may be expelling, for example viral contaminants. In other embodiments, for example, those lacking optional vents 140, it may be desired to allow a controlled amount of exhaust air 34 to escape from one or more the wrist closures 126 and/or waist closure 128, thereby retaining a desired level of positive pressure while allowing exhaust of carbon dioxide exhaled by user 10.

The upper body suit 110 can be constructed of materials that can be decontaminated and reused, for example, washable and reusable materials, or low-cost disposable/one-time use materials. The materials may be light-weight, waterproof or water-resistant material, for example, TYVECK available from and a trademark of DuPont de Nemours, Inc., of Wilmington, Del.; one or more layers of waterproof rip stop nylon, for example 70 denier; ZYTRON available from and a trademark of Kappler, Inc. of Guntersville, Ala.; and other resistant and/or impervious materials and gowns, known in the art, including for example, those available from O&M Halyard, Inc., of Alpharetta, Ga. Advantageously, in at least one embodiment the user 10 can select between donning an upper body suit 110 that is reusable or one that is disposable, for example, depending on the contaminants or other hazards in the environment or the activity planned in the environment.

The upper body suit 110 can be sewn together from portions of material that provide for better fit and size selections. The face shield 122 can be likewise sewn to the hood 120. The positive pressure provided to suit 110 by blower unit 200 generally prevents the need for additional sealing of seams beyond stitching for many applications; however, other forms of assembly, including sealing forms of assembly, for example, including adhesive glues and/or sealants known in the art, can be used instead of or in addition to stitching for applications requiring further levels of protection and/or enhanced failure mode safety.

The face shield 122 is located and sized to provide the user 10 with unrestricted forward visibility, for example, including about 270 degrees of lateral visibility. The face shield 122 may be formed from a flexible, semi-rigid, or rigid transparent vinyl or other suitable transparent barrier material known in the art, including depending on whether the associated suit 110 is intended for single-use or to be washed and reused.

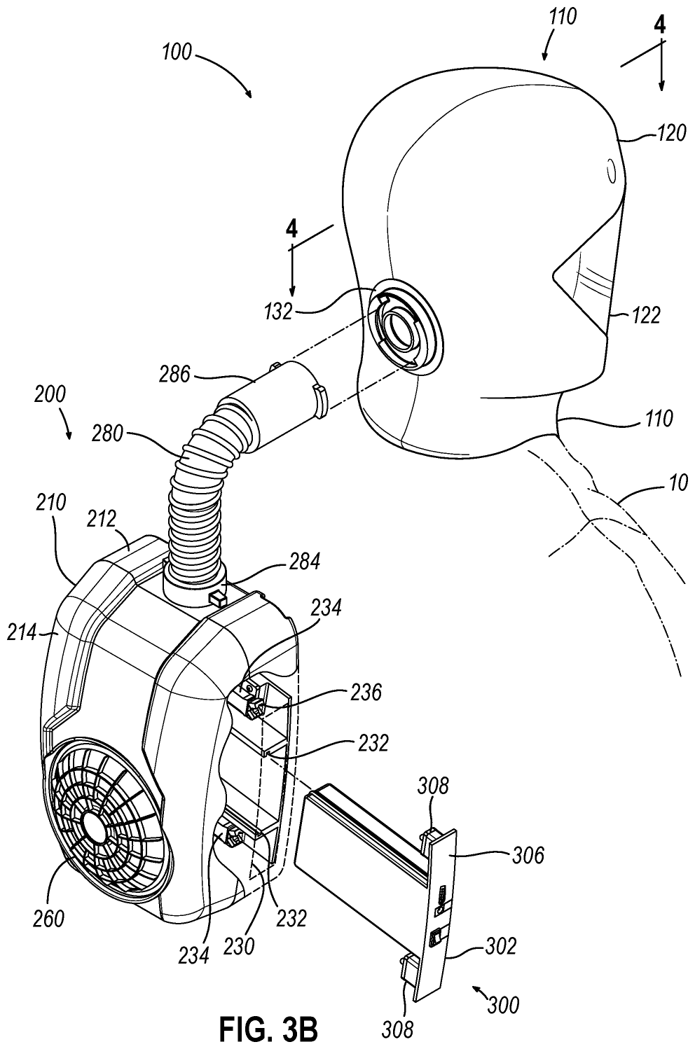

Referring to FIGS. 3A and 4, to facilitate locating and fixing the face shield 122 in a preferred position relative to the user's head 12 and face 14, for example, to maintain visibility and provide a breathing space 20 (FIG. 4) between the face 14 and shield 122, the user can don a reusable head harness 160 that releasably fixes the face shield 122 in place. Head harness 160 can include an adjustable diameter headband 162, shield support member 164, and optional crown strap 163. The rear 166 of the shield support member 164 is attached to the headband 162 and rests over the forehead portion of the user's head 12, above the user's face 14. The front 168 of the shield support member 164 can include an attachment feature for coupling the face shield 122 to the support member, for example, a releasably coupling.

In the illustrative embodiment, the top end of the face shield 122 includes a magnetic interface 130, for example, a metal band attached to the face shield, which operates to securely but releasably couple the face shield to a set of magnets 170 mounted on or imbedded in the front 168 of the support member 164. Alternatively, other magnetic or non-magnetic releasable clasping systems known in the art may be used. By donning the head harness 160 prior to donning the hood 120 of the upper body suit 110, upon the user 10 donning the hood 120, the face shield 122 can be magnetically attached and releasably fixed into position as desired in front of and spaced apart from the user's face 14, including their projecting nose, thus also reducing the likelihood of exhalation induced fogging of the face shield 122.

Referring to FIG. 3B, an air inlet is defined in the upper body suit 110, for example, by a hose connector 132 sealingly attached through the hood 120 at a lower rear portion of the hood, for example, adjacent a rear base of the user's head 12. The blower unit 200 provides filtered air 32 through the hose connector 132 and into an interior of the upper body suit 110, thereby providing the protective positive pressure for the suit. Connector 132 may be a quarter-turn or other connector formed from acrylonitrile butadiene styrene (ABS), an alternative thermoplastic polymer, polylactic acid (PLA) or an alternative thermoplastic polyester, or an alternative material known in the art and suitable for connection and coupling with filtered air supply hose 280 discussed below.

Referring to FIG. 3B and FIGS. 5-9, the blower unit 200 generally includes a housing 210, a carrying harness 220, a centrifugal blower 250, an intake filter 260, an air supply hose 280, and a power supply 300. Advantageously, the blower unit 200 in the exemplary embodiment of system 100 provides about 16 cubic feet per minute (CFM) of filtered air 32 through hose connector 132 for up to about 6 hours before replacing, recharging, or otherwise providing external power to power supply 300. Other embodiments provide over 16 CFM of filtered air 32, and yet other embodiments provide between 6 and 16 CFM of filter air. In contrast, typical prior art PAPR systems provide only 4-5 CFM of filtered air to a user and likely have a low static pressure capacity.

The exemplary embodiment of housing 210 of blower unit 200 includes a base 212, cover 214, and is attached to the carrying harness 220 by a mounting feature 216 defined by base 212, for example, an opening allowing a portion of harness 220 to extend through and anchor therein. The base 212 provides support for the components of blower unit 200, except the intake filter 260, which may be supported within filter recess 240 (FIG. 9) defined by the cover 214. The housing 210 can be formed from a rigid material, for example ABS, an alternative thermoplastic polymer, or an alternative material known in the art and suitable for supporting and providing protection from contaminants expected in the environment for the various components of blower unit 200. In an alternative embodiment the housing may be a semirigid or nonrigid fluid resistant material.

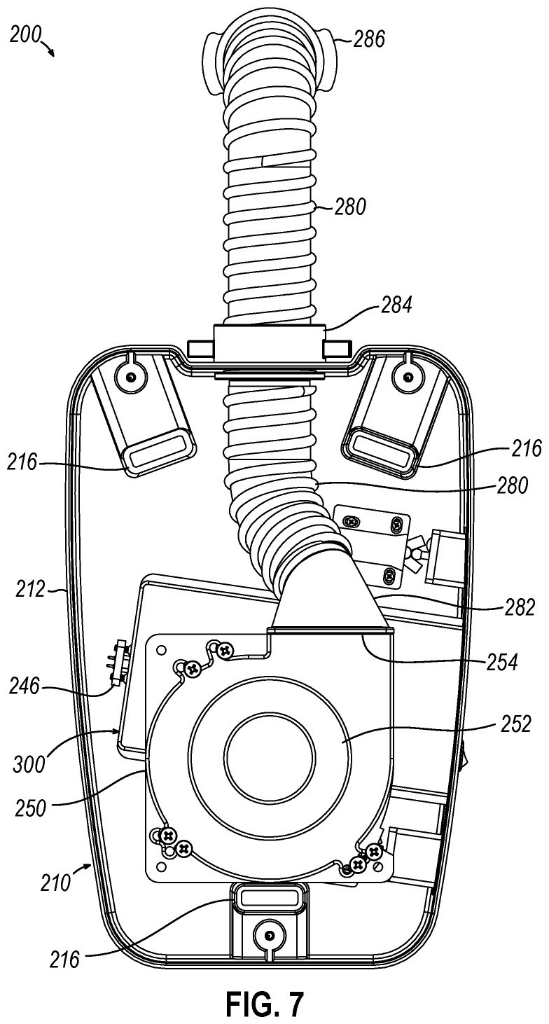

Referring to FIGS. 7 and 9, the blower 250 may be a centrifugal type of fan, for example, having a brushless DC motor as is typically used in computer cooling and other power efficient high output airflow applications, for example, centrifugal fans such as those rated as providing about 38 CFM unrestricted output and/or about 16 CFM at the static pressure presented by system 100. The centrifugal fan blower 250 used in the illustrative embodiment has a high static pressure capacity and thus provides the specified flow rate in a restricted flow environment of system 100, for example, centrifugal blower ball bearing fans available from ShenZhen Bai Wathai Technology CO., Ltd. of Shenzhen, China, for example, but not limited to, model # B08P1S5DBN.

High airflow volumes and high static pressure capacity are necessary to overcome flow resistance of biological reduction grade intake filter 260 through which intake air 30 is drawn, and to create the desired level of continuous positive pressure environment provided by the at least about 16 CFM of filtered air 32 delivered by the blower unit 200 to the suit 110. Other embodiments may include a smaller or a larger volume rate capacity blower(s) 250 depending on the particular features of system 100, including features of suit 110, and/or the level and nature of the hazards of the environment for which the system 100 is applied.

Referring to FIG. 9, the intake filter 260 is releasably received within a filter recess 240 of the cover 214 and provides contamination reduction grade filtration of intake air 30 drawn through intake aperture 242 and into the blower intake 252 of the centrifugal blower 250. For example, filter media 266 secured within cage 264 of filter housing 262 may include a biological reduction grade filter, for example, such as N95, N99, N100, P95, P99, P100 or the like, or corresponding biological reduction grade HEPA filter media, or other contamination reducing filter and absorption elements, including for example, but not limited to, multiple layers and/or materials such as activated carbon and/or other mechanical, biological, and chemical filter media. An exemplary dome-type HEPA filter of the type of intake filter 260 is available from Emerson ProTeam of St. Louis, Mo. Advantageously, the intake filter 260 can be removed from the filter recess 240 and replaced with a new intake filter as often as conditions and use warrant, for example, including after each use in a contaminated environment. Alternatively, the filter housing 262 may be reusable and facilitate replacement of only the filter media 266.

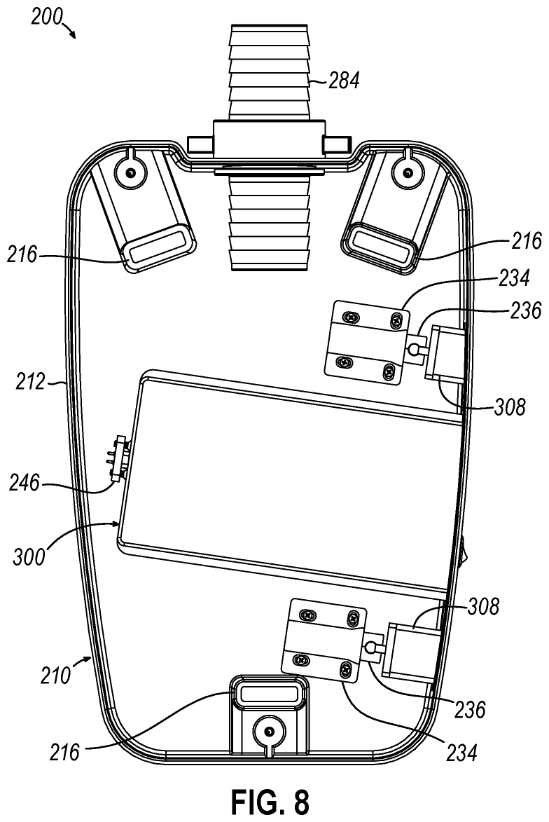

The blower outlet 254 from which filtered air 32 is expelled from blower 250 may be coupled to an air supply hose 280 by an adaptor 282. As illustrated by and understood from comparing FIGS. 7 and 8, the hose 280 may include a passthrough coupler 284 to which sections of hose 280 may be slidably pressed onto and retainably and sealingly engaged with to facilitate passage through the structure of the housing base 212. A connector 286 attached to a distal end of hose 280 may be configured to releasably and sealingly engage with the hose connector 132 of the upper body suit 110, for example, a quarter-turn engagement feature known in the art.

The sections of the hose 280 may be about 1½-inch to about 2-inch diameter hose or other sealed conduit structure, for example, constructed of polyethylene or another suitable material known in the art providing a sealed, flexible or semi-flexible transport and connection for filter air 32 delivered from the blower 250 to the suit 110. The adaptor 282, passthrough coupler 284, and connector 286 may be formed from ABS, an alternative thermoplastic polymer, or an alternative material known in the art and suitable to provide the function described herein.

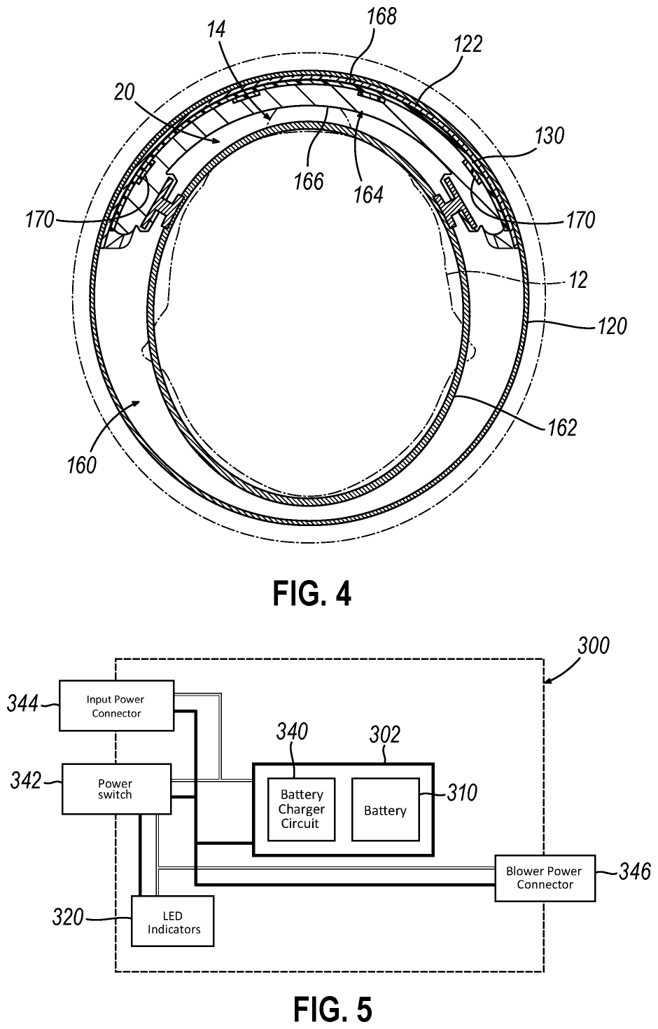

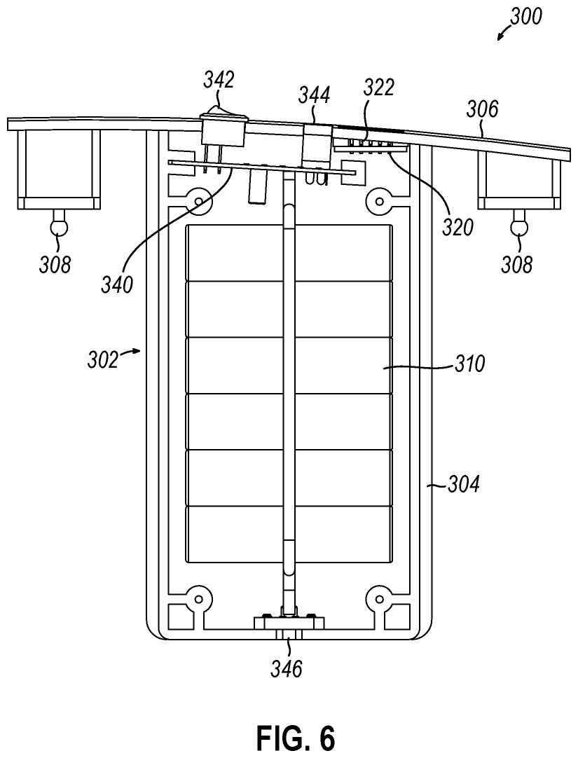

Referring to FIG. 5, a schematic block diagram of the power supply 300 of the blower unit 200 of the system 100 is illustrated. The power supply 300 in the exemplary embodiment is a swappable, rechargeable, and optionally externally powered unit providing at least about 6 hours of continuous operating power for the blower unit 200. The power supply 300 can include a swappable form factor battery cradle 302, which includes battery cells 310, a battery monitoring and charging circuit 340, an LED indicator board 320, a power switch 340, an external input power connector 344, and an output power connector 346. For example, referring to FIG. 6, the battery cradle 302 includes a housing 304 (shown with a cover removed) which is releasably retained within the housing 210 of the blower unit 200, as can be understood by comparing FIGS. 3A and 3B, and a panel 306, which forms a portion of the outside surface of housing 210 when the battery cradle 302 is received therein.

More specifically, an opening in base 212 of housing 210 exposes a receiving device for the battery cradle, for example, cradle rails 232 coupled to an interior of housing 210 that slidingly receive and guide the housing 304 of the battery cradle 302, for example by engaging with corresponding housing rails (shown but un-numbered), into securing engagement of the retaining post 308 of the battery cradle with retaining receivers 234 of the blower unit housing.

The interface of the retaining post 308 with the retaining arms 236 of the receivers 234 can provide a press to engage and lock the arms 236 onto the retaining post 308, thereby retaining the battery cradle 302 within the housing 200, and press again to release and eject the retaining post 308 from the arms 236 of the receivers 234, for example, by pressing the panel 306 into the housing 210. Advantageously, when the posts 308 are locked into engagement with the arms 236 of the receivers 234, for example as shown in FIG. 8, the output power connector 346 of the battery cradle 302 is engaged with and electrically connected to a corresponding blower power connector 246 located within the housing 210 and electrically coupled to power the blower 250.

In the exemplary embodiment, the battery cells 310 include six 1000 milliamp hour (mAh) 12 VDC rechargeable cells, for example, such as the 12-volt lithium-ion cells available from Talentcell of Shenzhen, Guangdong, China. The illustrative battery monitoring and charging circuit 340 and charge and power status LED indicator board 320 may also be of the type available from Talentcell for recharging, discharging in use, and monitoring use, capacity, and recharging of the battery cells 310. Advantageously, an external power connector 344 may be used to provide AC power to the power supply 300 if the circuit 340 includes power conversion and conditioning components, else to provide external DC power to the power supply 300. The external power source can be used to power the blower 250, to recharge the battery cells 310, or both, thereby providing continuous operation of the blower unit 200 for an unlimited amount of time.

Alternatively, upon the battery cells 310 of the battery cradle 302 being depleted of power, or nearly depleted, for example, as indicated by LED indicator board 320 and light pipes 322 transmitting indications to the outer surface of the panel 306, the battery cradle can be removed from housing 210 and replaced with a fully recharged battery cradle. Advantageously, spare battery cradles 302 not currently in use can be recharged so that they can be hot swapped with a depleted battery cradle as needed while a user 10 has donned and is still using the system 100, thereby extending continuous portable usage beyond the time capacity provided by a single battery cradle. Other embodiments may include different types of power supplies 300, including different types of battery cells 310 with different voltages, amperages, and/or chemical compositions.

Referring to FIGS. 1 and 2, the carrying harness 220 can be worn by the user 10 to support and carry the blower unit 200 adjacent the back 116 of the jacket 112 portion of the suit 110. The harness 220 can include shoulder straps 222, a waist belt 224, harness closures 226 for securing the waist belt 224 and the shoulder straps 222 onto the user 10, and strap connectors 228 for securing portions of the harness 220 together, for example, connecting the shoulder straps 222 to the waist belt 224, and connecting the harness 220 to the blower unit 200. Configurations other than the backpack configuration of the carrying harness 220 for supporting the blower unit 200 to be carried by the user 100 can alternatively be employed, including for example a waist pack configuration as is known in the art.

The carrying harness 220 may be constructed of nylon webbing or other suitable materials known in the art. The harness 220 may include padding for comfort and may be coated or use a different base material to reduce slippage and/or improve resistance and ease of removing contaminants from the harness 220.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure and the appended claims.

Reference systems that may be used herein can refer generally to various directions (e.g., upper, lower, forward and rearward), which are merely offered to assist the reader in understanding the various embodiments of the disclosure and are not to be interpreted as limiting.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

### ELEMENT NUMBERING

The following is a list of reference numerals appearing in the drawings and at least one noun used to describe the element associated with each reference numeral. The embodiments disclosed herein are not limited to these descriptions, and these elements can further include other words that would be understood by a person of ordinary skill reading and reviewing this disclosure in its entirety, and other words that may be used in other locations of this document.

| | | | |
|---|---|---|---|
| 10 | user | 14 | face |
| 12 | head | 20 | space |
| 30 | ambient intake air | 163 | crown strap |
| 32 | filtered air | 164 | shield support member |
| 34 | exhaled air | 166 | rear |
| 36 | exhaust air | 168 | front |
| 100 | protection system | 170 | magnetic clasp |
| 110 | upper body suit | 200 | blower unit |
| 112 | jacket | 210 | housing |
| 114 | front | 212 | base |
| 116 | back | 214 | cover |
| 118 | sleeves | 216 | harness mounting feature |
| 120 | hood | 220 | carrying harness |
| 122 | face shield | 222 | shoulder strap |
| 124 | zipper | 224 | waist belt |
| 126 | wrist closure | 226 | harness closures |
| 128 | waist closure | 228 | harness connector |
| 130 | magnetic interface | 230 | battery opening |
| 132 | hose connector | 232 | cradle rails |
| 140 | vent | 234 | retaining receiver |
| 142 | opening | 236 | retaining arms |
| 144 | flap | 240 | filter recess |
| 146 | vent filter | 242 | intake aperture |
| 160 | head harness | 246 | blower power connector |
| 162 | headband | 250 | centrifugal blower |
| 252 | blower intake | 302 | battery cradle |
| 254 | blower outlet | 304 | housing |
| 260 | intake filter | 306 | panel |
| 262 | filter housing | 308 | retaining post |
| 264 | cage | 310 | battery cells |
| 266 | filter media | 320 | indicator board |
| 280 | hose | 322 | light pipe |
| 282 | adaptor | 340 | monitoring/charging circuit |
| 284 | passthrough | 342 | power switch |
| 286 | connector | 344 | external power connector |
| 300 | power supply | 346 | power output connector |

What is claimed is:

1. A positive pressure protection system for a user, comprising:
an upper body suit having a jacket, sleeves, and hood portions providing a fluid resistant barrier for the user, the jacket including a waist closure, and the hood portion including a transparent face shield;
a carrying harness adapted for wear by the user overtop of the upper body suit; and
a blower unit supported by the carrying harness, the blower unit including:
a housing;
an intake air filter coupled to the housing;
a blower fan supported by the housing and having an inlet coupled with the intake air filter and having an outlet;
a conduit coupling the blower fan outlet to an interior of the upper body suit; and
a power supply supported by the housing and providing electrical power to the blower fan.

2. The positive pressure protection system of claim 1, further comprising:
a face shield support member having a releasable coupling for securing and positioning the face shield relative to the user's face and head; and
a head harness for wear on the head of the user, the shield support member supported by the head harness.

3. The positive pressure protection system of claim 2, wherein the releasable coupling includes a magnetic fastener defined by at least a portion of the shield support member and a portion of the face shield.

4. The positive pressure protection system of claim 1, wherein the intake air filter includes biological reduction grade filter media.

5. The positive pressure protection system of claim 1, wherein the intake air filter includes chemical filter media.

6. The positive pressure protection system of claim 1, wherein the upper body suit defines at least one flap covered vent defined therethrough to allow release of exhaled carbon dioxide from the user and sized to maintain positive pressure within the suit.

7. The positive pressure protection system of claim 6, wherein the at least one flap covered vent is covered with a biological reduction grade filter media, the media providing a barrier to the escape of biological contaminants exhaled or otherwise shed by the user.

8. The positive pressure protection system of claim 1, wherein the sleeves include wrist closures.

9. The positive pressure protection system of claim 1, wherein the front of the jacket includes a fluid sealing zipper to aid the user in donning and doffing the upper body suit.

10. The positive pressure protection system of claim 1, wherein the user can select from an upper body suit constructed of materials suitable for one-time disposable use, and an upper body suit constructed of materials that can be washed or otherwise decontaminated and reused.

11. The positive pressure protection system of claim 1, wherein the blower fan is a centrifugal fan having a combined flow rate capacity and static pressure capacity to deliver at least about 16 cubic feet per minute of filtered air flow to the upper body suit.

12. The positive pressure protection system of claim 1, wherein the power supply includes rechargeable batteries.

13. The positive pressure protection system of claim 12, wherein the power supply includes a power input connector for recharging the rechargeable batteries onboard and enabling continuous time unbounded operation of the blower unit.

14. The positive pressure protection system of claim 12, further comprising a receptacle for releasably receiving at least a portion of the power supply within the blower unit.

15. The positive pressure protection system of claim 14, wherein the receptacle includes an opening defined by the blower unit housing and a blower power connector for receiving power from the power supply.

16. The positive pressure protection system of claim 14, wherein:
the receptacle includes guides for slidingly receiving at least a portion of the power supply into the blower unit housing; and
the receptacle and the power supply include a releasable retaining device for releasably securing the power supply in the blower unit housing.

17. The positive pressure protection system of claim 1, wherein:
the hood includes a hose connector; and
the conduit includes a hose releasably connectable to the hose connector for supplying filtered air to the interior of the upper body suit.

18. A positive pressure protection system for a user, comprising:
an upper body suit providing a fluid resistant barrier for the user, the upper body suit including a waist closure, wrist closures, and a hood portion including a transparent face shield;
a face shield support member having a releasable coupling for securing and positioning the face shield relative to the user's face and head;
a head harness for wear on the head of the user, the shield support member supported by the head harness; and
a blower unit including:
a housing;
an ambient air intake filter coupled to the housing;
a blower fan located within the housing and having an inlet coupled with the intake filter and having an outlet;
a sealed conduit coupling the blower fan outlet to an interior of the upper body suit; and
a power supply supported within the housing and providing electrical power to the blower fan.

19. The positive pressure protection system of claim 18, further comprising a carrying harness adapted for wear by the user overtop of the upper body suit, the carrying harness supporting the blower unit and including shoulder straps and a waist belt.

20. A positive pressure protection system for a user, comprising:
a protection suit providing a fluid resistant barrier for the user, the protection suit including at least an upper body portion and further including a hood portion having a transparent face shield; and
a blower unit including:
a housing;
an ambient air intake filter coupled to the housing;
a blower fan positioned within the housing and having an inlet coupled with the intake filter and having an outlet;
a sealed conduit coupling the blower fan outlet to an interior of the suit;
a rechargeable power supply; and
a receptacle for releasably receiving at least a portion of the power supply within the blower unit housing; and
wherein:
the receptacle includes an opening defined by the blower unit housing and a blower power connector for receiving power from the power supply;
the receptacle includes guides for slidingly receiving at least a portion of the power supply into the blower unit housing; and
the receptacle and the power supply include a releasable retaining device for releasably securing the power supply in the blower unit housing.
